(19) United States
(12) Patent Application Publication
(10) Pub. No.: US 2025/0102336 A1
(43) Pub. Date: Mar. 27, 2025

(54) ULTRASONIC FLOWMETER AND MEASURING ARRANGEMENT

(71) Applicant: Krohne AG, Basel (CH)

(72) Inventor: Eduard BOTTER, Wateringen (NL)

(73) Assignee: Krohne AG, Basel (CH)

(21) Appl. No.: 18/893,110

(22) Filed: Sep. 23, 2024

(30) Foreign Application Priority Data
Sep. 22, 2023 (DE) 10 2023 125 768.4

(51) Int. Cl. G01F 1/667

(52) U.S. Cl. CPC G01F 1/667

(57) ABSTRACT

An ultrasonic flowmeter for insertion into a pipe of a pipe system at the location of a flange connection of the pipe system, with a measuring tube having a longitudinal axis for guiding a flowable medium and with a flange for fastening the measuring tube in the pipe system. The measuring tube has at least one first transducer pocket for receiving a first ultrasonic transducer and at least one second transducer pocket for receiving a second ultrasonic transducer. A first ultrasonic transducer is arranged in the first transducer pocket and a second ultrasonic transducer is arranged in the second transducer pocket. The measuring tube is designed as a thin-walled tube such that the wall thickness of the measuring tube is less than the extension of the transducer pockets perpendicular to the longitudinal axis of the measuring tube, and the transducer pockets extend into the outer space of the measuring tube.

This nonprovisional application claims priority under 35 U.S.C. § 119 (a) to German Patent Application No. 10 2023 125 768.4, which was filed in Germany on Sep. 22, 2023, and which is herein incorporated by reference.

### BACKGROUND OF THE INVENTION

### Field of the Invention

The invention relates to an ultrasonic flowmeter for insertion into a first pipe of a pipe system at a location of a flange connection of the pipe system, with a measuring tube having a longitudinal axis for guiding a flowable medium and with a flange for at least indirect fastening of the measuring tube in the pipe system, wherein the measuring tube has at least one first transducer pocket for receiving a first ultrasonic transducer and at least one second transducer pocket for receiving a second ultrasonic transducer, wherein a first ultrasonic transducer is arranged in the first transducer pocket, which is designed as an ultrasonic transmitter and/or as an ultrasonic receiver, and wherein a second ultrasonic transducer is arranged in the second transducer pocket, which is designed as an ultrasonic transmitter and/or as an ultrasonic receiver.

Furthermore, the invention relates to a measuring arrangement comprising an ultrasonic flowmeter according to the invention and at least a first tube of the tube system, wherein the measuring tube is inserted into the first tube.

### Description of the Background Art

Ultrasonic flow meters are known in the conventional art and are used to determine the flow velocity and thus the flow rate of the flowable medium.

Ultrasonic flow meters form a part of the pipe system. These ultrasonic flowmeters, also known as inline flowmeters, are usually inserted into the pipe system via two flanges and thus form an independent part of the flow path of the medium. Consequently, the measuring tube must meet all the tightness and stability requirements that the pipe system must also meet, especially with regard to pressure and temperature resistance. Since the ultrasonic transducers are inserted into the measuring tube, the transducer pockets provided for this purpose and the connections between the transducer pocket and the ultrasonic transducer must also meet the stability requirements. Since the ultrasonic transducers protrude from the measuring tube, there is also a need for—at least mechanical—shielding of the transducers in the form of a housing.

The situation is different for the ultrasonic flowmeters whose measuring tube is inserted into a pipe of a pipe system, i.e. into the interior of the pipe. These ultrasonic flowmeters therefore do not form an independent part of the flow path of the medium. Usually, at the mounting point of such ultrasonic flowmeters, a first pipe comes together with a first pipe flange and a second pipe with a second pipe flange of the pipe system, wherein the first pipe flange and the second pipe flange then implement a flange connection between the first pipe and the second pipe. To fix the measuring tube in the pipe system, the measuring tube is inserted into the first pipe or the second pipe of the pipe system and the flange of the measuring tube is clamped between the first pipe flange and the second pipe flange. Often the measuring tube can be surrounded by the medium to a large extent, so that the question of pressure resistance practically does not arise, and tightness aspects are also not critical. Known ultrasonic flowmeters are often complex in design and inflexible in their application.

### SUMMARY OF THE INVENTION

It is therefore an object of the invention to provide an ultrasonic flowmeter mentioned such that it has a simple structure and is flexible in terms of its application. Furthermore, it is an object of the invention to provide a measuring arrangement comprising the ultrasonic flowmeter according to the invention.

The object is initially and essentially achieved in an example of the ultrasonic flowmeter according to the invention, in that the measuring tube is designed as a thin-walled tube in such a way that the wall thickness of the measuring tube is less than the extension of the transducer pockets perpendicular or substantially perpendicular to the longitudinal axis of the measuring tube. Moreover, in the ultrasonic flowmeter according to the invention, the transducer pockets extend into the outer space of the measuring tube.

It has been recognized that the physical boundary conditions when the measuring tube is used in the first pipe of the pipe system (no differential pressure between the inner and outer space of the measuring tube) allow very far-reaching design measures. The thin-walled design of the measuring tube is not only advantageous because this results in a significant reduction in the material required for manufacturing, it is also advantageous because thin-walled measuring tubes allow the use of generic manufacturing processes (for example, 3D printing) that might otherwise have seemed impractical. Furthermore, the thin-walled measuring tube design also results in minimal reduction in the internal cross-section of the tube of the pipe system in which the measuring tube is inserted.

Thin-walled, in the sense of the present patent application, means that the wall thickness of the measuring tube is less than the extension of the transducer pockets perpendicular to the longitudinal axis of the measuring tube. The absolute wall thickness depends on the diameter of the measuring tube and is chosen accordingly by the person skilled in the art.

The design according to the invention allows a significant saving of material and thus a reduction of material costs.

The transducer pockets can also be designed in the measuring tube in such a way that they extend into the outer space of the measuring tube. This has the advantage that the transducer pockets do not protrude into the interior of the measuring tube and thus not into the flow cross-section of the medium, so that the medium is not disturbed by the transducer pockets, which could result in vortex formation, for example.

In order to be able to insert the measuring tube into a tube of the pipe system and to attach it to the tube, a flange can be provided. A particularly preferred design of the ultrasonic flowmeter according to the invention is distinguished by the fact that the measuring tube and the flange are designed as one-piece. One-piece means that the measuring tube and the flange do not comprise two interconnected workpieces, but are manufactured from a single workpiece or are produced as a single workpiece. This has the advantage that the flange and the measuring tube do not have to be joined together. This eliminates the need for fasteners and also simplifies the manufacturing process. Since the measuring tube and flange are one piece, there is also no risk of leakage in a—non-existent—connection area. In addition, it is not necessary to adapt different material properties to each other, as would be the case if the flange and measuring tube were made of different materials. Preferably, the transducer pockets are also designed in one piece with the measuring tube.

The measuring tube and the flange can be made of a plastic. In particular, the use of glycol-modified polyethylene terephthalate (PETG for short), acrylonitrile butadiene styrene (ABS for short), polypropylene (PP for short), acrylonitrile styrene acrylic ester (ASA for short) or nylon is suitable here. It is also advantageous to use polyetheretherketone (PEEK for short) as the material for manufacturing the measuring tube and the flange.

An advantage of using plastic is that the measuring tube and the flange are lightweight. The use of electrically non-conductive plastic also has the advantage that ultrasonic transducers arranged in the transducer pockets are automatically electrically isolated from one another. In addition, sound propagation in plastics is also generally poorer than in metals, so that the problem of transmitting parasitic ultrasound via the measuring tube is reduced.

The measuring tube and the flange can be manufactured via a generative manufacturing process. This further minimizes the manufacturing effort.

Also, the measuring tube and the measuring tube flange can be made of epoxy resin.

The measuring tube and the flange can be made of different materials. For example, the flange is made of a pressure-resistant material, such as epoxy resin, and the measuring tube is made of a plastic material mentioned above. According to this design, the measuring tube and the flange are subsequently joined together.

The measuring tube can have at least two transducer pockets for receiving two ultrasonic transducers. One of the ultrasonic transducers is designed at least as an ultrasonic transmitter, and the other ultrasonic transducer is designed at least as an ultrasonic receiver. Preferably, both ultrasonic transducers are designed as both ultrasonic transmitters and ultrasonic receivers. Together, the two ultrasonic transducers span a measurement path. To increase the measuring accuracy, it is useful to implement more than one measuring path, wherein the measuring paths preferably run through different areas of the measuring tube. In an exemplary design of the ultrasonic flowmeter according to the invention, the measuring tube has at least one further transducer pocket for accommodating a further ultrasonic transducer, a reflector or a terminating body for implementing further measurement paths. The measuring tube has not only one further transducer pocket, but can have a plurality of further transducer pockets for receiving further ultrasonic transducers, reflectors or terminators for implementing further measurement paths. Ultrasonic transducers do not necessarily have to be arranged in the transducer pockets; rather, reflectors can also be arranged in the transducer pockets, on which an ultrasonic signal is reflected. In addition to the advantage of being able to implement further measuring paths, the design according to the invention has the advantage that the measuring tubes can be prefabricated independently of their actual use. Depending on the measuring situation, the measuring tubes can be individually equipped with ultrasonic transducers or reflectors. In addition, the invention provides that end pieces can also be arranged in the transducer pockets. These end pieces then form only part of the inner wall of the measuring tube and are inserted in the transducer pockets wherever neither an ultrasonic transducer nor a reflector is provided. The measuring tubes described can thus be used very flexibly, because they can be configured quite differently with little effort. Thus, with the same number of ultrasonic transducers, very different measurement paths can be implemented, but also very different complex measurement path arrangements can be implemented with very different numbers of ultrasonic transducers. All this is possible with a single type of prefabricated measuring tube, if an appropriate number of transducer pockets is provided.

The longitudinal axes of the transducer pockets can be perpendicular or substantially perpendicular to the longitudinal axis of the measuring tube. In an alternative variation, the longitudinal axes of the transducer pockets are at an angle not equal to 90° on the longitudinal axis of the measuring tube. In a further variation, the longitudinal axes of different transducer pockets are at different angles on the longitudinal axis of the measuring tube. For example, the angle between the longitudinal axis of the measuring tube and the longitudinal axis of at least part of the transducer pockets is between 30° and 50°, in particular about 45°. The orientation of the transducer pockets depends on the measuring paths to be implemented. The transducer pockets have at least partially different angles to the longitudinal axis of the measuring tube, wherein preferably each two ultrasonic transducers implementing a common measuring path have equal angles to the longitudinal axis of the measuring tube.

The ultrasonic flowmeter can have at least one further sensor, in particular a pressure sensor and/or one temperature sensor, arranged in one of the transducer pockets. This results in the advantage that the pressure sensor and/or the temperature sensor can be arranged close to the medium, in particular in contact with the medium, in the ultrasonic flowmeter without, however, influencing the flow of the medium. Preferably, several pressure sensors and/or temperature sensors can be arranged in several transducer pockets, whereby, on the one hand, the temperature or the pressure can be measured at several points, and, on the other hand, measurements can be carried out with another sensor if one of the sensors fails.

In order to be able to fix the ultrasonic transducers, the reflectors, the terminators and/or the sensors—such as temperature sensor and/or pressure sensor—in the transducer pocket, various designs are provided according to the invention.

In a first variation, the ultrasonic transducers, the reflectors, the terminators and/or the sensors and the transducer pockets have mutually corresponding retaining projections and retaining recesses. The retaining projections engage in the retaining recesses so that a positive connection is produced. In one variation, the retaining projections are designed on the elements to be inserted in the transducer pockets and the retaining recesses in the transducer pockets. In another variation, the retaining projections are designed in the transducer pockets and the retaining recesses on the elements to be inserted. Also provided is that both retaining recesses and retaining projections are designed on the elements to be inserted and correspondingly in the transducer pockets. In other embodiments, the retaining projections are formed by O-rings retained in circumferential recesses in the transducer pocket, in the ultrasonic transducer, in the reflectors, in the terminating body and/or in the sensors.

The retaining projections and the retaining recesses can be designed to be interrupted in the circumferential direction of the transducer pockets and the elements to be inserted. This enables precise positioning of the elements to be inserted.

At least one or more tongue-like latching elements can be provided on the elements to be inserted and/or on the transducer pockets. Additionally or alternatively, at least one elastic latching element or several elastic latching elements are provided. The tongue-like and/or elastic latching elements are arranged on the elements to be inserted and/or in the transducer pockets. Retaining projections are provided correspondingly. When the elements to be inserted are inserted into the transducer pockets, the tongue-like and/or elastic elements are then pretensioned by the retaining projection in order to return to an at least partially relaxed state after the retaining projection has passed, thus forming a projection that retains the retaining projection.

The ultrasonic flowmeter can have a control and evaluation unit. The control and evaluation unit can be provided outside the tube system in which the measuring tube is inserted. In order to guide the electrical lines from the ultrasonic transducers to the control and evaluation unit, the electrical lines are guided from the ultrasonic transducers, preferably through the flange to the control and evaluation unit.

The flange can be formed at least in part by a printed circuit board which implements a partial section of the electrically conductive connection between the ultrasonic transducers and the control and evaluation unit.

The flange can implement an electrical feedthrough. The flange can have contact elements for contacting at least the ultrasonic transducers on the one hand and at least one contact element for contacting the control and evaluation unit on the other. Particularly preferably, the flange has a contact element for each ultrasonic transducer. In this case, the contact elements for the ultrasonic transducers are arranged in the interior of the pipe system in the assembled state, and the contact element for connection to the control and evaluation unit is arranged in the exterior of the pipe system.

This design has the advantage that there is no need for a further component to perform the electrical feed-through into the outer space of the pipe system.

Also, the ultrasonic flowmeter can have a control and evaluation unit which, in the assembled state, is arranged outside the pipe system, wherein the control and evaluation unit is connected at least to the ultrasonic transducers via electrical lines, and wherein the ultrasonic flowmeter has a printed circuit board, wherein the printed circuit board, in the assembled state, is arranged between the first pipe flange of the first pipe and the second pipe flange of the second pipe in such a way that it implements the electrical connection of at least the ultrasonic transducers from the interior of the pipe system to the exterior of the pipe system.

The printed circuit board has contact elements at least for the ultrasonic transducers, which in the mounted state are arranged in the interior of the pipe system, and preferably for the at least one further sensor, if present, and preferably a contact element for contacting the control and evaluation unit, which in the mounted state is arranged outside the pipe system. The control and evaluation unit can be connected to the contact element of the printed circuit board via a cable connection.

In addition, the control and evaluation unit can also be arranged directly on the printed circuit board. For example, the control and evaluation unit can be connected to the printed circuit board via a plug connection or a clamp connection or a solder connection. In particular, the control and evaluation unit can be designed as an additional printed circuit board or can have an additional printed circuit board.

Furthermore, the printed circuit board can also be equipped directly with the control and evaluation unit.

In the latter designs, no further cable connection is required between the control and evaluation unit and the printed circuit board.

The control and evaluation unit can also be arranged on this printed circuit board in accordance with one of the previously described connections in the case where the flange of the measuring tube is designed as a printed circuit board.

For mounting, the printed circuit board can be arranged and/or clamped between the first pipe flange of the first pipe and the second pipe flange of the second pipe of the pipe system.

The flange of the measuring tube can be fixed to the printed circuit board, for example the flange and the printed circuit board are screwed together. According to this design, the outer diameter of the flange can also be smaller than the inner diameter of the first tube into which the measuring tube is inserted, so that the measuring tube can be inserted completely into the first tube and is fixed only by the connection to the printed circuit board. According to this design, the flange does not clamp between the first pipe flange and the second pipe flange when mounted.

The measuring tube can be coated on its outer side with an electrically insulating layer. The electrically insulating layer can be implemented after the transducer pockets have been fitted with the ultrasonic transducers, so that the electrical leads of the ultrasonic transducers are electrically shielded by the electrically insulating layer on the one hand and fixed to the measuring tube on the other.

In order to prevent crosstalk of ultrasonic waves to the tube system, the measuring tube can have an acoustically insulating layer on its outside. This minimizes crosstalk of the ultrasonic waves as interfering housing waves.

A particularly preferred design of the ultrasonic flowmeter according to the invention is characterized in that the measuring tube can have a constant internal cross section. In an alternative preferred variation, the measuring tube has a variable internal cross-section along its longitudinal axis. The flow profile of the medium can be advantageously influenced by the choice of the internal cross-section.

An inner diameter of the measuring tube at the transition to the pipeline can correspond to the inner pipeline diameter. The smooth transition between the pipeline and the measuring tube minimizes disturbance of the flow profile. The inner diameter of the measuring tube at the transition to the pipeline can be smaller than the inner pipeline diameter.

Provided further is a measuring arrangement comprising one of the ultrasonic flowmeters described above and at least a first tube of the tube system, wherein the measuring tube is inserted into the first tube, that the first tube and the measuring tube are adapted to each other in such a way that the transducer pockets do not contact the first tube.

For example, the diameter of the first tube can be enlarged at least in the area where the measuring tube is inserted. Particularly preferably, the inner diameter of the measuring tube is substantially equal to the inner diameter of the second tube of the tube system and the inner diameter of the first tube in the area where the diameter is not enlarged, provided that the first tube has an enlargement of the inner diameter only in some areas.

The measuring tube may have a reduced measuring tube cross-section at least in the region of the transducer pockets.

The inner cross-sectional area of the measuring tube can be smaller than the inner cross-sectional area of the first tube in such a way that the transducer pockets do not touch the first tube in the inserted state.

According to further advantageous designs of the measuring arrangement, reference is made to the above description insofar as it concerns special designs of the measuring arrangement.

In particular, the measuring arrangement can have a second pipe, wherein the first pipe has a first pipe flange and wherein the second pipe has a second pipe flange and wherein the measuring tube is arranged with the measuring tube flange between the first pipe flange and the second pipe flange or wherein the measuring tube is arranged with the measuring tube flange on a printed circuit board which is clamped between the first pipe flange and the second pipe flange.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation of a first example of an ultrasonic flowmeter,

FIG. 2 shows a first measuring tube of an ultrasonic flowmeter,

FIG. 3 shows a second measuring tube of an ultrasonic flowmeter,

FIG. 4 shows an ultrasonic transducer,

FIG. 5 shows an ultrasonic transducer inserted into a transducer pocket,

FIG. 6 shows a transducer pocket,

FIG. 7 shows another illustration of a measuring tube,

FIG. 8 shows a representation of the measuring tube and an additional printed circuit board for the electrical connection of the ultrasonic transducers and the control and evaluation unit,

FIG. 9 shows a measuring arrangement comprising an ultrasonic flowmeter and a pipe system, and

FIG. 10 shows a further measuring arrangement including an ultrasonic flowmeter and a pipe system.

### DETAILED DESCRIPTION

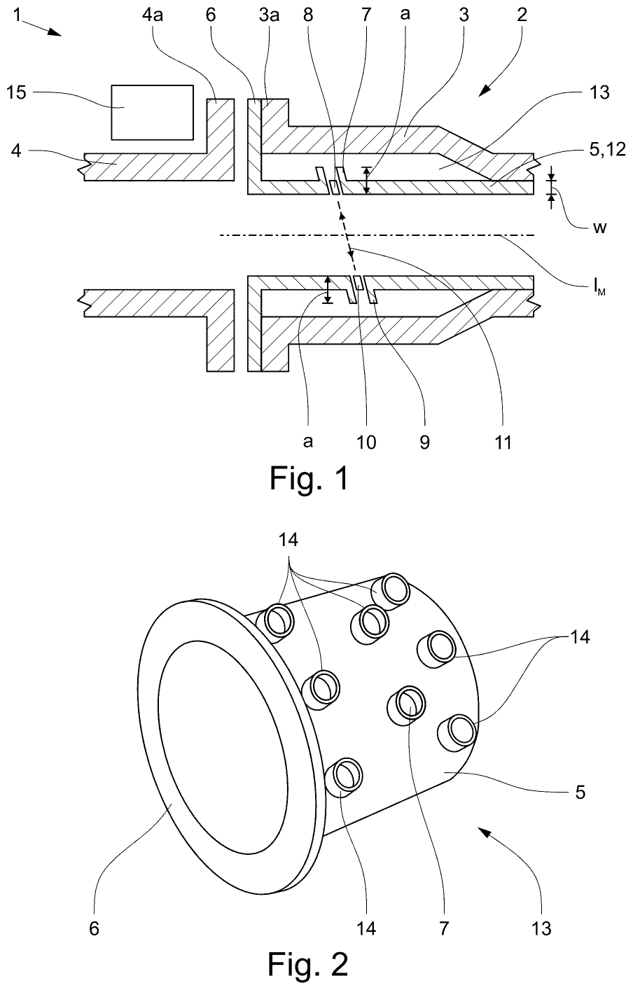

FIG. 1 shows a schematic representation of an ultrasonic flowmeter 1 designed for insertion into a pipe system 2, wherein the pipe system 2 comprises at least a first pipe 3 with a first pipe flange 3a and a second pipe 4 with a second pipe flange 4a. The ultrasonic flowmeter 1 has a measuring tube 5 having a longitudinal axis IM, which is used to guide a flowable medium, and a flange 6 for fixing the measuring tube 5 in the pipe system 2. The flange 6 of the measuring tube 5 is clamped between the first tube flange 3a and the second tube flange 4a in the illustrated embodiment. For better clarity, the second pipe flange 4 has a distance to the flange 6. In the assembled state, the flange 6 is naturally clamped tightly between the pipe flanges 3a and 4a.

The measuring tube 5 has a first transducer pocket 7 in which a first ultrasonic transducer 8 is arranged, and it has a second transducer pocket 9 in which a second ultrasonic transducer 10 is arranged. The two ultrasonic transducers 8, 10 are designed as both ultrasonic transmitters and ultrasonic receivers, and transmit and receive ultrasonic signals that propagate along a measurement path 11. The measuring tube 5 is designed as a thin-walled tube 12 and is characterized in that the wall thickness w of the measuring tube 11 is less than the extension a of the transducer pockets 7, 9 perpendicular to the longitudinal axis IM of the measuring tube 5. In addition, the transducer pockets 7, 9 extend into the outer space 13 of the measuring tube 5. As can be seen from the figures, the transducer pockets 7, 9 extend exclusively into the outer space 13 of the measuring tube 5, i.e. they do not project into the inner space of the measuring tube 5. The transducer pockets do not touch the first tube 3, so that crosstalk to the first tube can be avoided or at least reduced during operation. For this purpose, the diameter of the first tube 3 is enlarged in the area of the measuring tube 5, in particular in the area of the transducer pockets 7.

A control and evaluation unit 15 is used to control the ultrasonic transducers 8, 10 and to evaluate the ultrasonic signals. The electrical supply lines to the ultrasonic transducers 8, 10 are not shown in FIG. 1. The control and evaluation unit 15 is located outside the pipe system 2 and thus also outside the measuring tube 5.

As can be seen in FIG. 1, the measuring tube 5 and the flange 6 are designed in one piece. In the present case, the measuring tube 5 and the flange 6 are made of plastic via a generative manufacturing process, namely via 3D printing. Alternatively, the complete insert comprising the measuring tube 5 and the measuring tube flange 6 can also be made of epoxy resin.

FIG. 2 shows another design of the measuring tube 5 with flange 6 for the ultrasonic flowmeter 1. The measuring tube 5 has a plurality of transducer pockets 14 in which ultrasonic transducers, reflectors, sensors such as temperature sensors and pressure sensors, and end pieces can be accommodated. End pieces close transducer pockets, resulting in a continuous measuring tube inner surface. Depending on the equipment of the measuring tube 5, a plurality of further measuring paths can be implemented.

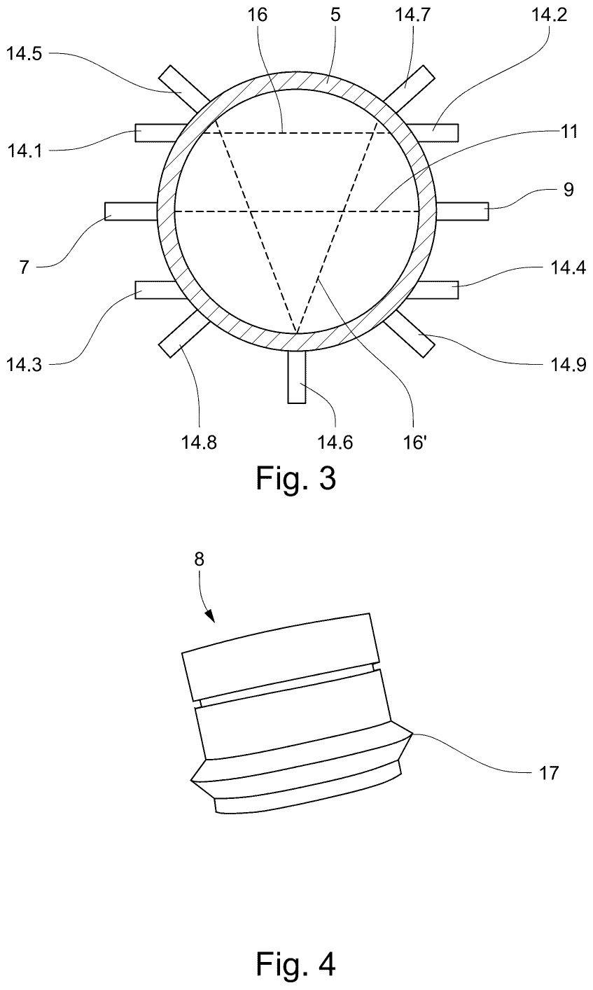

FIG. 3 shows a cross-section of a measuring tube 5. In addition to the first transducer pocket 7, in which a first ultrasonic transducer 8 is arranged, and the second transducer pocket 9, in which a second ultrasonic transducer 10 is arranged, the measuring tube 5 has a plurality of further transducer pockets 14.1, 14.2, 14.3, 14.4, 14.5, 14.6 14.7, 14.8 and 14.9. Two ultrasonic transducers are also arranged in the transducer pockets 14.1 and 14.2, but they are not visible in the illustration. A second measurement path 16 is implemented by these two ultrasonic transducers. In the transducer pockets 14.3 and 14.4, only end pieces are arranged which are flush with the inner wall of the measuring tube 5. The end pieces can be replaced by further ultrasonic transducers if the implementation of a further measuring path is desired. Two ultrasonic transducers are also arranged in the transducer pockets 14.5 and 14.7. A reflector is arranged in the transducer pocket 14.6. This implements a further measurement path 16′. A temperature sensor for measuring the temperature of the medium is arranged in the transducer pocket 14.8. The transducer pocket 14.9 accommodates a pressure sensor for determining the pressure.

FIG. 4 schematically shows an ultrasonic transducer 8 that can be inserted into a transducer pocket 7. The ultrasonic transducer 8 has a retaining projection 17 which engages in a corresponding retaining recess 18 of the transducer pocket 7 when the ultrasonic transducer 8 is inserted, so that the ultrasonic transducer can be held positively in the transducer pocket. The ultrasonic transducer shown can therefore be easily arranged in a transducer pocket in an exchangeable manner.

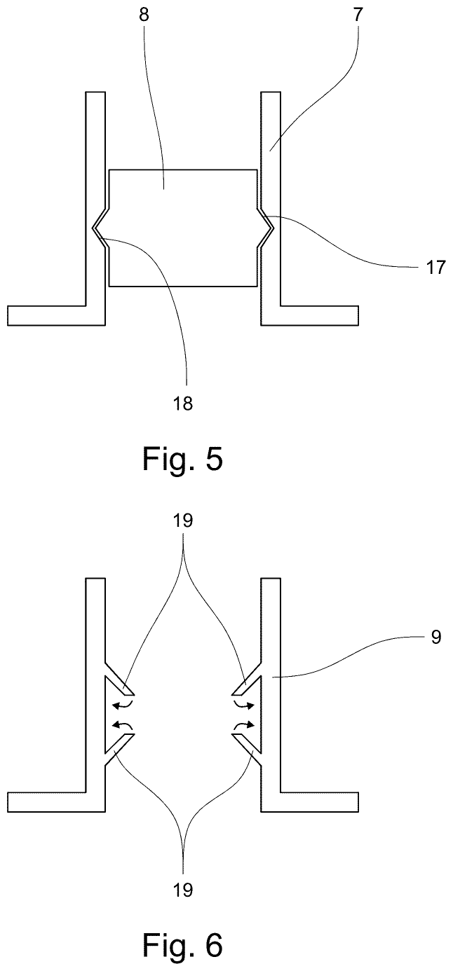

FIG. 5 shows a schematic representation of the ultrasonic transducer 8 inserted into the transducer pocket 7. To allow the ultrasonic transducer 8 to be inserted through the transducer pocket 7 to the retaining recess 18, the retaining projection 17 has elasticity that allows the retaining projection 17 to deform. Alternatively, the transducer pocket 7 may be designed to be elastic and allow easy insertion of the ultrasonic transducer 8 into the transducer pocket.

FIG. 6 is a schematic illustration of a cross-section of a transducer pocket 9 on which tongue-like retaining elements 19 are designed. When an ultrasonic transducer 10, which has a retaining projection, is inserted into the transducer pocket 9, the tongue-like retaining elements 19 are elastically deflected by the retaining projection in the direction of the arrow. As soon as the retaining projection has passed the tongue-like retaining elements 19, they return to their initial position and hold the ultrasonic transducer—depending on the specific design—in a form-fitting and/or force-fitting manner. Generic manufacturing processes can now be used to produce very filigree structures, so that a large number of practicable retaining designs can be implemented.

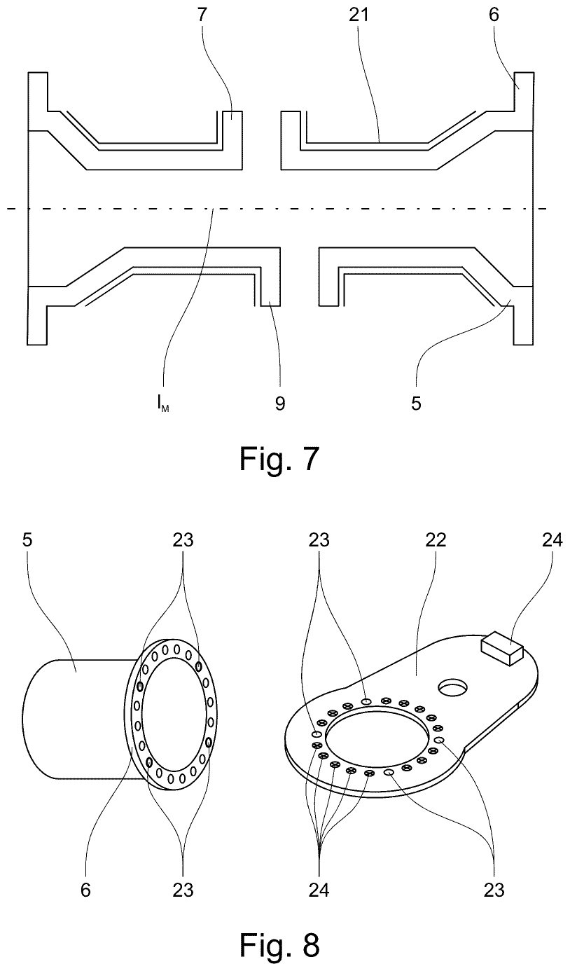

FIG. 7 is a schematic representation of a further measuring tube 5. The measuring tube 5 is coated on its outside with an acoustically insulating layer 21. In addition, the measuring tube 5 has an internal cross section that varies along its longitudinal axis IM. By reducing the internal cross-section, it is ensured in the installed state that the transducer pockets 7 and 9 do not contact the first tube 3 of the pipe system, so that crosstalk to the first tube 3 can at least be reduced.

FIG. 8 shows an embodiment of a measuring tube 5 with a flange 6 and a printed circuit board 22. The printed circuit board 22 and the measuring tube flange 6 have holes 23 that are adapted to each other in such a way that the flange 6 can be screwed to the printed circuit board 22.

In addition, the printed circuit board 22 has contact elements 24 which can be connected to the electrical conductors of the ultrasonic transducers or further sensors, for example, via a plug-in connection. In the embodiment shown, the contact elements 24 are arranged in a circle around the recess of the printed circuit board 22. Each ultrasonic transducer and, if provided, each sensor can be connected to a contact element. For this purpose, the flange 6 has further holes through which electrical leads of the ultrasonic transducers can be routed.

In addition, the printed circuit board 22 has a further contact element 24 for connection to the control and evaluation unit. The contact element 24 for connection to the control and evaluation unit 15 is arranged in such a way that it is outside the pipe system when installed. The circuit board 22 is designed as a whole in such a way that it can be clamped between the first pipe flange 3a of the first tube 3 and the second pipe flange 4a of the second tube 4, so that both the circuit board 22 and the measuring tube 5 are fixed in the tube system.

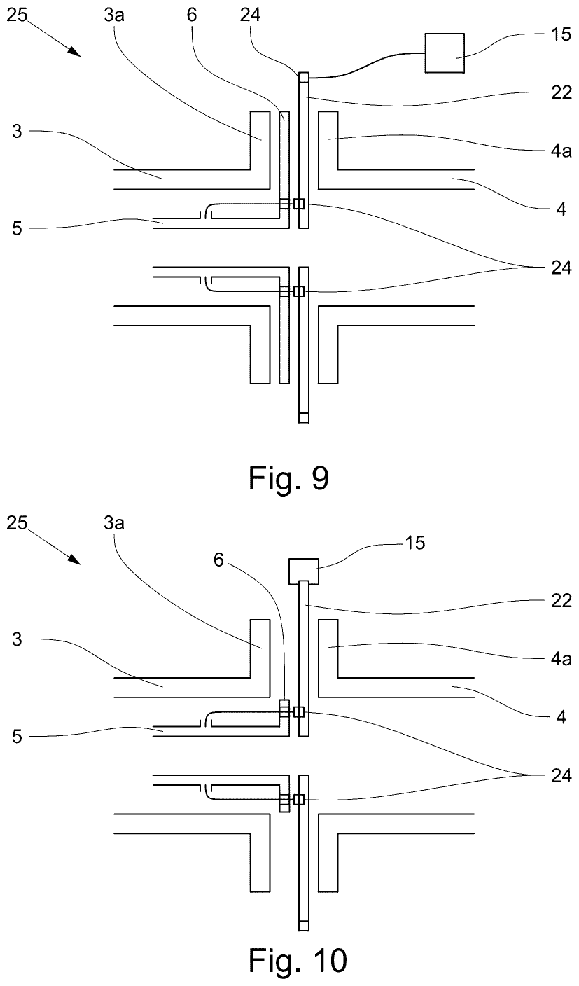

FIG. 9 shows an embodiment of a measuring arrangement 25 with an ultrasonic flowmeter 1 comprising a measuring tube 5 with a measuring tube flange 6, wherein the measuring tube 5 has transducer pockets 14 in which ultrasonic transducers 8, 10 not explicitly shown here are arranged. The flange 6 is clamped between the first pipe flange 3a and the second pipe flange 4a. In addition, a printed circuit board 22 is provided, which is also clamped between the first pipe flange 3a and the second pipe flange 4a.

The printed circuit board 22 is screwed to the measuring tube flange 6. In addition, the circuit board 22 has contact elements 24 which are connected to the electrical conductors of the ultrasonic transducers. For this purpose, holes are provided in the flange 6 through which the electrical conductors are guided.

Furthermore, the printed circuit board has a further contact element 24 in the outer space of the pipe system, which is connected to the control and evaluation unit 15 also arranged in the outer space of the pipe system.

To ensure good clarity, there are gaps between the individual components in the illustration. Of course, in operation, the measuring tube flange 6 and the printed circuit board 22 are tightly clamped between the flanges 3a and 4a.

Overall, the illustrated measuring arrangement 25 has the advantage that the ultrasonic flowmeter 1 can be used in various measuring environments due to the leveling of the measuring tube 5.

FIG. 10 shows a further embodiment of a measuring arrangement 25. In contrast to the measuring arrangement shown in FIG. 9, the measuring tube 5 and the flange 6 are arranged completely within the first pipe 3. The measuring tube 5 is screwed to the printed circuit board 22 via bore holes in the flange 6. The printed circuit board 22 is clamped between the tube flanges 3a and 4a and thus forms a feedthrough for the signal transmission. At the same time, the connection between the printed circuit board 22 and the tube flanges is a sealed connection.

In addition, the control and evaluation unit 15 is arranged directly on the printed circuit board 22 and connected to it via a clamp connection. This arrangement eliminates the need for an additional cable connection between the control and evaluation unit and the printed circuit board, which in turn saves costs.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An ultrasonic flowmeter for insertion into a first pipe of a pipe system at a location of a flange connection of the pipe system, the ultrasonic flowmeter comprising:
a measuring tube, which has a longitudinal axis, is adapted to guide a flowable medium, the measuring tube having at least one first transducer pocket to receive a first ultrasonic transducer and at least one second transducer pocket to receive a second ultrasonic transducer;
a flange for at least indirect fastening of the measuring tube in the pipe system,
a first ultrasonic transducer arranged in the first transducer pocket, the first ultrasonic transducer being an ultrasonic transmitter and/or an ultrasonic receiver; and
a second ultrasonic transducer arranged in the second transducer pocket, the second ultrasonic transducer being an ultrasonic transmitter and/or an ultrasonic receiver,
wherein the measuring tube is designed as a thin-walled tube such that the wall thickness of the measuring tube is less than an extension of the first or second transducer pockets that is substantially perpendicular to the longitudinal axis of the measuring tube, and
wherein the first and second transducer pockets extend into an outer space of the measuring tube.

2. The ultrasonic flowmeter according to claim 1, wherein the measuring tube and the flange are formed in one piece, wherein the measuring tube and the flange are designed from a plastic, and/or wherein the measuring tube and the flange are manufactured via a generative manufacturing process.

3. The ultrasonic flowmeter according to claim 1, wherein the measuring tube has at least one further transducer pocket to receive a further ultrasonic transducer, a reflector or a terminating body for implementing further measurement paths, wherein the measuring tube has a plurality of further transducer pockets to receive further ultrasonic transducers, reflectors or terminating bodies for implementing further measurement paths.

4. The ultrasonic flowmeter according to claim 3, wherein at least one pressure sensor and/or one temperature sensor is arranged in the at least one further transducer pocket.

5. The ultrasonic flowmeter according to claim 1, wherein the ultrasonic transducers, reflectors, terminating bodies, sensors, and/or the transducer pockets have corresponding retaining projections and retaining recesses to fasten the ultrasonic transducers, the reflectors, terminating bodies and/or sensors in the transducer pockets.

6. The ultrasonic flowmeter according to claim 1, wherein the ultrasonic transducers, reflectors, terminating bodies, sensors and/or the transducer pockets have tongue-like and/or elastic latching elements to fasten the ultrasonic transducers, the reflectors, terminating bodies, and/or sensors in the transducer pockets.

7. The ultrasonic flowmeter according to claim 1, further comprising a control and evaluation unit arranged outside the pipe system, wherein electrical lines from the ultrasonic transducers, reflectors, terminating bodies, or the sensors are led through the flange to the control and evaluation unit.

8. The ultrasonic flowmeter according to claim 7, wherein the flange is formed at least partially by a printed circuit board which implements part of the electrically conductive connection between the ultrasonic transducers and the control and evaluation unit.

9. The ultrasonic flowmeter according to claim 1, further comprising:
a control and evaluation unit arranged outside the pipe system in a mounted state, wherein the control and evaluation unit is connected at least to the ultrasonic transducers via electrical lines; and
a printed circuit board, which, in an assembled state, is adapted to arranged between the first pipe flange of the first pipe and the second pipe flange of the second pipe such that an electrical connection from an interior of the pipe system to an exterior of the pipe system is implemented.

10. The ultrasonic flowmeter according to claim 1, wherein the measuring tube is coated on an outer side with an electrically insulating layer or wherein the flange is at least partially coated with an electrically insulating layer.

11. The ultrasonic flowmeter according to claim 1, wherein the measuring tube is coated on an outer side with an acoustically insulating layer.

12. The ultrasonic flowmeter according to claim 1, wherein the measuring tube has a constant internal cross section, or wherein the measuring tube has a variable internal cross section along the longitudinal axis.

13. The ultrasonic flowmeter according to claim 1, wherein an inner diameter of the measuring tube at a transition to the pipe system corresponds to an inner tube diameter of the pipe system, or wherein the inner diameter of the measuring tube at the transition to the pipe system is smaller than the inner tube diameter of the pipe system.

14. A measuring arrangement comprising:
an ultrasonic flowmeter according to claim 1; and
at least a first tube of the tube system,
wherein the measuring tube is inserted into the first tube,
wherein the first tube and the measuring tube are adapted to each other such that the transducer pockets do not contact the first tube.
